(19) United States
(12) Patent Application Publication
(10) Pub. No.: US 2025/0304602 A1
(43) Pub. Date: Oct. 2, 2025

(54) SYNTHESIZING YTTRIUM COMPLEXES

(71) Applicant: ENTEGRIS, INC., Billerica, MA (US)

(72) Inventors: Vagulejan Balasanthiran, Pennsburg, PA (US); Scott A. Laneman, Vernon Hills, IL (US); Smita Patnaik, Warrington, PA (US); Iryna Alshakova, Philadelphia, PA (US)

(21) Appl. No.: 19/093,933

(22) Filed: Mar. 28, 2025

Related U.S. Application Data
(60) Provisional application No. 63/571,664, filed on Mar. 29, 2024.

(51) Int. Cl. C07F 5/00

(52) U.S. Cl. CPC C07F 5/00

(57) ABSTRACT

Methods for forming yttrium complexes are provided herein. A method for forming a yttrium complex comprises contacting a yttrium trihalide adduct with a cyclopentadienyl compound in a presence of a solvent to form a yttrium complex. Compositions are provided. A composition comprises a precursor compound. The precursor compound comprises a yttrium complex formed according to the methods disclosed herein. Various other methods and compositions are provided herein.

### CROSS-REFERENCE TO RELATED APPLICATIONS

This application claims the benefit under 35 USC 119 of U.S. Provisional Patent Application No. 63/571,664, filed Mar. 29, 2024, the disclosure of which is hereby incorporated herein by reference in its entirety.

### FIELD

The present disclosure relates to synthesizing yttrium complexes, and related compositions and related methods.

### BACKGROUND

Conventional processes for synthesizing yttrium complexes utilize excess reagents, resulting in unnecessary waste. Producing yttrium complexes at high conversions and in high yields remains an ongoing challenge for conventional processes.

### SUMMARY

Some embodiments of the present disclosure relate to a method comprising: contacting a yttrium trihalide adduct with a cyclopentadienyl compound in a presence of a solvent to form a first product, wherein the yttrium trihalide adduct comprises a compound of the formula:

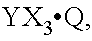

where:
X is CI, Br, or I; and
Q is an ethereal solvent;
wherein the cyclopentadienyl compound comprises a compound of the formula:

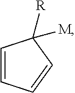

where:
R is an alkyl; and
M is a metal.

In some embodiments, the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

In some embodiments, the alkyl comprises a C₁-C₁₀ alkyl.

In some embodiments, the alkyl comprises a C₁-C₈ alkyl.

In some embodiments, the alkyl comprises at least one of a methyl, an ethyl, an isopropyl, or any combination thereof.

In some embodiments, the alkyl is substituted with at least one substituent comprising a heteroatom.

In some embodiments, the metal comprises sodium (Na), potassium (K), or lithium (Li).

In some embodiments, the solvent comprises at least one of dichloromethane (DCM), chlorobenzene, dichlorobenzene, dichloroethane (DCE), N-methyl-2-pyrrolidone (NMP), dibutyl ether (nBu₂O) or any combination thereof.

In some embodiments, the yttrium trihalide adduct comprises YX3.2THF.

In some embodiments, the method does not comprise a step of adding tetrahydrofuran.

In some embodiments, the first product comprises a compound of the formula:

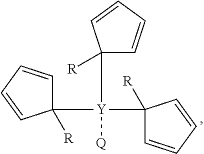

where:
R is independently an alkyl; and
Q is an ethereal solvent.

In some embodiments, the method further comprises:
removing the ethereal solvent from the first product to obtain a second product of the formula:

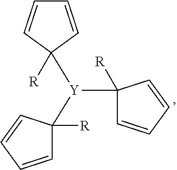

where:
R is independently an alkyl.

Some embodiments of the present disclosure relate to a composition comprising: a precursor compound of the formula:

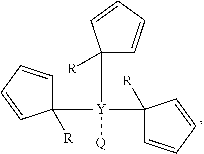

where:
R is independently an alkyl; and
Q is an ethereal solvent;
wherein a purity of the precursor compound in the composition is at least 95%.

In some embodiments, the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

In some embodiments, the alkyl comprises a C₁-C₁₀ alkyl.

In some embodiments, the alkyl comprises a C₁-C₈ alkyl.

In some embodiments, the alkyl comprises at least one of a methyl, an ethyl, an isopropyl, or any combination thereof.

Some embodiments of the present disclosure relate to a composition comprising: a precursor compound of the formula:

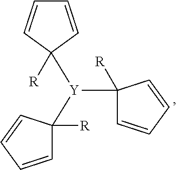

where:
R is independently an alkyl;
wherein a purity of the precursor compound in the composition is at least 95%.

In some embodiments, the alkyl comprises a C₁-C₁₀ alkyl.

In some embodiments, the alkyl comprises at least one of a methyl, an ethyl, an isopropyl, or any combination thereof.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a method of forming a yttrium complex, according to some embodiments.

FIG. 2 depicts a reaction scheme of forming a yttrium complex, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “contacting” refers to bringing two or more components into immediate or close proximity, or into direct contact, including mixing, combining, agitating, stirring, or any other suitable means.

As used herein, the term “removing” refers to separating, eliminating, distilling, sorting, dissociating, detaching, disconnecting, diving, splitting, sifting, isolating, transferring, or any other suitable means.

As used herein, the term “alkyl” refers to a hydrocarbon compound having from 1 to 30 carbon atoms. An alkyl having n carbon atoms may be designated as a “Cn alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₈alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

As used herein, the term “alkyl” refers to a hydrocarbon chain radical having from 1 to 30 carbon atoms. The alkyl may be attached via a single bond. An alkyl having n carbon atoms may be designated as a “Cn alkyl.” For example, a “C₈ alkyl” may include n-propyl and isopropyl. An alkyl having a range of carbon atoms, such as 1 to 30 carbon atoms, may be designated as a C₁-C₃₀ alkyl. In some embodiments, the alkyl is saturated (e.g., single bonds). In some embodiments, the alkyl is unsaturated (e.g., double bonds and/or triple bonds). In some embodiments, the alkyl is linear. In some embodiments, the alkyl is branched. In some embodiments, the alkyl is substituted. In some embodiments, the alkyl is unsubstituted. In some embodiments, the alkyl may comprise, consist of, or consist essentially of, or may be selected from the group consisting of, at least one of a C₁-C₁₂ alkyl, a C₁-C₁₁ alkyl, a C₁-C₁₀ alkyl, a C₁-C₈ alkyl, a C₁-C₈ alkyl, a C₁-C₇ alkyl, a C₁-C₆ alkyl, a C₁-C₄ alkyl, a C₁-C₈alkyl, or any combination thereof. In some embodiments, the alkyl may comprise, consist of, or consist essentially of, or may be selected from the group consisting of, at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, octyl, decyl, dodecyl, octadecyl, or any combination thereof.

As used herein, the term “halide” refers to a —Cl, —Br, —I, or —F.

As used herein, the term “aryl” refers to an aromatic ring comprising carbon and hydrogen atoms. Examples of aryls include, without limitation, phenyl, biphenyl, napthyl, and the like.

As used herein, the term “metal” refers to at least one of an alkali metal, an alkaline earth metal, a transition metal, a post-transition metal, a lanthanoid, or any combination thereof. In some embodiments, for example, the metal comprises or is selected from the group consisting of a transition metal. In some embodiments, the metal comprises or is selected from the group consisting of a Group VIB metal. In some embodiments, the metal comprises or is selected from the group consisting of at least one of sodium (Na), potassium (K), or lithium (Li). In some embodiments, the metal is in ionic form, elemental form, or any combination thereof.

As used herein, the term “ethereal solvent” refers to a solvent that comprises, consists of, or consists essential of, or is selected from the group consisting of, an ether. In some embodiments, the ether comprises, consists of, or consists essential of, or is selected from the group consisting of, an alkyl group, an aryl group, or combinations thereof. In some embodiments, the ethereal solvent(s) is an organic solvent. In some embodiments, the ethereal solvent comprises, consists of, or consists essentially of, or is selected from the group consisting of, tetrahydrofuran (THF), 2-methyl tetrahydrofuran (2-Me THF), diethyl ether (Et₂O), dimethoxyethane (DME), di-n-butyl ether (nBu₂O) or any combination thereof. It will be appreciated that other precursor materials may be used herein without departing from this disclosure.

Solubility of yttrium complexes in certain solvents, such as, ether and tetrahydrofuran, is limiting, resulting in turbidity, among other things. This turbidity is understood to result in formation of various intermediate species, such as, for example and without limitation, salts or cationic and/or anionic species, which hinders or prevents the reaction from taking place, and which results in low conversions and low yields (e.g., <60%). Conventional methods further use excess tetrahydrofuran as a solvent, resulting in unnecessary waste and providing challenges for scaleup. Embodiments provided herein overcome these and other challenges of conventional methods by providing a method for synthesizing yttrium complexes sufficient to result in higher conversions and higher yields. It is understood that, in some embodiments, the methods provided herein proceed without formation of any reaction-hindering intermediate species, such as, for example and without limitation, the anionic species and/or cationic species present in conventional methods. For example, in some embodiments, the methods incorporate the use of certain solvents that promote monomer formation of reactive species and that are more susceptible to reaction with cyclopentadienyl to improve conversion and yield of yttrium complexes.

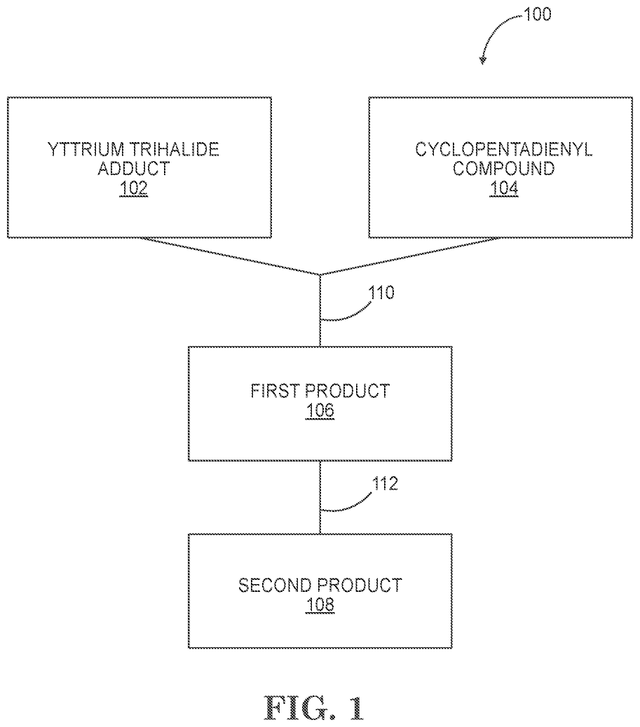

FIG. 1 depicts a method 100 of forming a product, according to some embodiments. As shown in FIG. 1, the method 100 of forming a product may comprise, consist of, or consist essentially of one or more of the following steps: contacting 110 a yttrium trihalide adduct 102 with a cyclopentadienyl compound 104 in a presence of a solvent to form a first product 106.

In some embodiments, the yttrium trihalide adduct 102 comprises a compound of the formula YX3.Q, where X is CI, Br, or I and Q is an ethereal solvent. In some embodiments, a yttrium trihalide compound is used over the yttrium trihalide adduct 102. In some embodiments, the yttrium trihalide adduct does not comprise ionic species (e.g., an anionic species, a cationic species, or any combination thereof). In some embodiments, the yttrium trihalide adduct is not an adduct. For example, in some embodiments, the method comprises contacting 110 a yttrium trihalide compound with a cyclopentadienyl compound 104 in a presence of a solvent to form a first product 106.

In some embodiments, the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

In some embodiments, the yttrium trihalide adduct 102 comprises YX3.2THF.

In some embodiments, the cyclopentadienyl compound 104 comprises a compound of the formula:

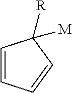

where:
R is an alkyl, and
M is a metal.

In some embodiments, the alkyl comprises a C₁-C₁₀ alkyl. In some embodiments, the alkyl comprises a C₁-C₈ alkyl.

In some embodiments, the alkyl comprises at least one of a methyl, an ethyl, an isopropyl, or any combination thereof. In some embodiments, the alkyl is substituted with at least one substituent comprising a heteroatom.

In some embodiments, the metal comprises sodium (Na), potassium (K), or lithium (Li).

In some embodiments, the solvent comprises at least one of dichloromethane (DCM), chlorobenzene, dichlorobenzene, dichloroethane (DCE), N-methyl-2-pyrrolidone (NMP), or any combination thereof. In some embodiments, the solvent comprises a solvent other than tetrahydrofuran.

In some embodiments, the method 100 does not comprise a step of adding tetrahydrofuran.

In some embodiments, the first product 106 comprises a compound of the formula:

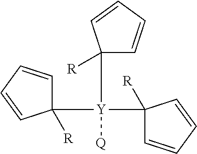

where:
R is independently an alkyl; and
Q is an ethereal solvent.

In some embodiments, the method 100 further comprises removing 112 the ethereal solvent from the first product 106 to obtain a second product 108 of the formula:

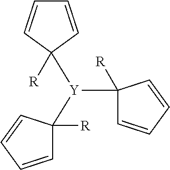

where R is independently an alkyl.

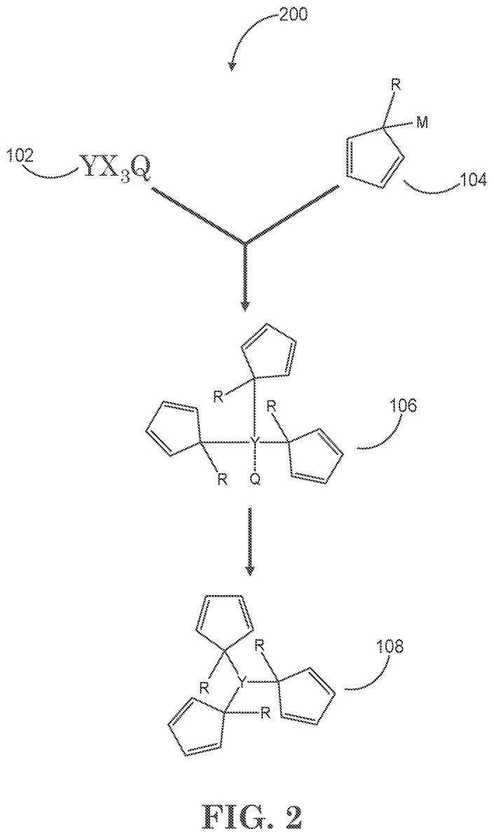

FIG. 2 depicts a reaction scheme 200 of forming a product, according to some embodiments. As shown in FIG. 2, the yttrium trihalide adduct 102 is contacted with the cyclopentadienyl compound 104 to form the first product 106. In some embodiments, the ethereal solvent from the first product 106 is removed to obtain a second product 108 of the formula:

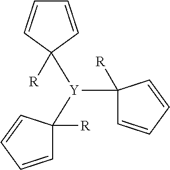

where:
R is independently an alkyl.

Some embodiments relate to a composition. In some embodiments, the composition comprises a compound of the formula:

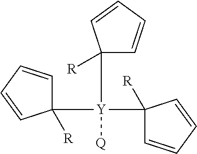

where:
R is independently an alkyl; and
Q is an ethereal solvent.

In some embodiments, a purity of the product in the composition is at least 95%. In some embodiments, a purity of the product in the composition is at least 96%, at least 97%, at least 98%, or at least 99%. In some embodiments, a purity of the product is 95% to 99.9999%, 95% to 99.999%, 95% to 99.99%, 95% to 99.9%, 95% to 99%, 95% to 98%, 95% to 97%, 95% to 96%, 96% to 99.9999%, 97% to 99.9999%, 98% to 99.9999%, 98% to 99.9999%, 99% to 99.9999%, 99.9% to 99.9999%, 99.99% to 99.9999%, or 99.999% to 99.9999%.

In some embodiments, the alkyl comprises a C₁-C₁₀ alkyl. In some embodiments, the alkyl comprises a C₁-C₈ alkyl. In some embodiments, the alkyl comprises at least one of a methyl, an ethyl, an isopropyl, or any combination thereof.

In some embodiments, the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

In some embodiments, the composition comprises a compound of the formula:

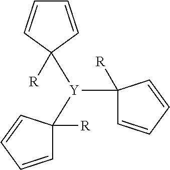

where:
R is independently an alkyl.

In some embodiments, a purity of the product in the composition is at least 95%. In some embodiments, a purity of the product in the composition is at least 96%, at least 97%, at least 98%, or at least 99%. In some embodiments, a purity of the product is 95% to 99.9999%, 95% to 99.999%, 95% to 99.99%, 95% to 99.9%, 95% to 99%, 95% to 98%, 95% to 97%, 95% to 96%, 96% to 99.9999%, 97% to 99.9999%, 98% to 99.9999%, 98% to 99.9999%, 99% to 99.9999%, 99.9% to 99.9999%, 99.99% to 99.9999%, or 99.999% to 99.9999%.

In some embodiments, the alkyl comprises a C₁-C₁₀ alkyl. In some embodiments, the alkyl comprises a C₁-C₈ alkyl. In some embodiments, the alkyl comprises at least one of a methyl, an ethyl, an isopropyl, or any combination thereof.

In some embodiments, the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

### Example 1

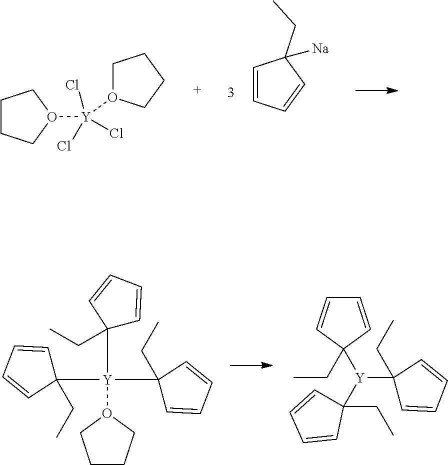

Tris(ethylcyclopentadienyl) (EtCp₃) yttrium (III) complex (EtCp₃Y) was prepared using YCl₃·2THF and EtCpNa with mixed solvents of dichloromethane (DCM). The YCl₃·2THF and EtCpNa was mixed with DCM at room temperature to produce EtCpsY, and then subjected to filtration and distillation. Yield for EtCp₃Y·THF was >88% after filtration. Yield for EtCp₃Y after distillation was >70% and purity for EtCp₃Y after distillation was >98%.

### Example 2

### Synthesis of YCl₃·2THF from 10 g anhydrous YCl₃

Anhydrous YCl₃ (10.0 g; 51.2 mmol) was dispersed in 100 ml of DCM under nitrogen environment in a 500 mL flask. Anhydrous THF (7.75 g; 110 mmol) was added dropwise under stirring. The resulting mixture was stirred for 3 h at room temperature and then all the undissolved material was allowed to settle for 5 h. The DCM solution was filtrated, and all the volatiles were removed under vacuum, resulting in 17.01 g of YCl₃·2THF with 97.8% yield and 99.2% purity by ¹H-NMR.

¹H-NMR (500 MHz NMR): 1.88 ppm (m, 8 H, CH₂) and 3.92 ppm (m, 8 H, OCH₂)

¹³C-NMR (125 MHz NMR): 12.80 ppm (CH₂) and 70.09 ppm (OCH₂)

### Example 3

### Synthesis of YCl₃·2THF from 20 g anhydrous YCl₃

Anhydrous YCl₃ (20.0 g; 102 mmol) was dispersed in 250 ml of DCM under nitrogen environment in a 500 mL flask. Anhydrous THF (15.5 g; 215 mmol) of was added dropwise to the YCl₃ solution while maintaining the stirring. The resulting mixture was stirred for 3 h at room temperature and then all the undissolved material was allowed to settle for 5 h. The DCM solution was filtrated, and all the volatiles were removed under vacuum, resulting in 34.27 g of YCl₃·2THF with 98.56% yield and 98.7% purity by ¹H-NMR.

¹H-NMR (500 MHZ NMR): 1.88 ppm (m, 8 H, CH₂) and 3.92 ppm (m, 8 H, OCH₂)

¹³C-NMR (125 MHz NMR): 25.80 ppm (CH₂) and 70.09 ppm (OCH₂)

### Example 4

### Synthesis of YCl₃·2THF from 150 g anhydrous YCl₃

Anhydrous YCl₃ (150 g; 0.77 mol) was dispersed in 1300 g of DCM under nitrogen environment in a 3 L flask. Anhydrous THF (116.2 g; 1.61 mol) was added dropwise to the YCl₃ solution while maintaining the stirring. The resulting mixture was stirred for 3 h at room temperature and then all the undissolved material was allowed to settle overnight. The DCM solution was separated, and all the volatiles were evaporated under vacuum, resulting in 255.7 g of YCl₃·2THF with 98.05% yield and 98.71% purity by ¹H-NMR.

¹H-NMR (500 MHZ NMR): 1.88 ppm (m, 8 H, CH₂) and 3.92 ppm (m, 8 H, OCH₂)

¹³C-NMR (125 MHz NMR): 25.80 ppm (CH₂) and 70.09 ppm (OCH₂)

### Example 5

Other variations of the tris(alkylcyclopentadienyl) yttrium (III) complex were prepared similarly to the synthesis described in Example 1. A summary of the various reactions is presented in Table 1 below.

TABLE 1

| | YCl₃•2THF | | | | |
|---|---|---|---|---|---|
| Experiment | (g) | Salt | RCp₃Y•THF(Yield %) | RCp₃Y(Yield %) | Purity % |
| 1 | 2 | EtCpNa | 91 (R = Et) | * | — |
| 2 | 20 | EtCpNa | 90 (R = Et) | 76 | 98.2 |
| 3 | 254.7 | EtCpNa | 89.4(R = Et) | 72 | 99.5 |
| 4 | 2 | EtCpK | 81 (R = Et) | * | — |
| 5 | 5 | MeCpNa | 88 (R = Me) | * | — |

* Distillation/sublimation is not performed.

Experiment 1: YCl₃·2THF (2 g; 5.9 mmol) was dissolved in 30 mL of DCM under nitrogen environment in a 100 mL flask. EtCpNa (2.12 g; 18 mmol) was dissolved in 30 mL DCM in a separate flask under nitrogen environment. DCM solution of EtCpNa was charged slowly to the YCl₃·2THF containing flask under stirring at 0-5° C. After the addition completed, the resulting mixture was allowed to warm to room temperature and stirred for 3 h. Then, all the volatiles were removed, and the product was extracted in hexanes. Product was concentrated under reduced pressure, resulting in 2.46 g of pale yellow crystalline EtCp₃Y·THF crude material with 96.1% purity by ¹H-NMR.

¹H-NMR (500 MHZ NMR): 1.18 ppm (bs, 4H, OCH₂CH₂), 1.2 ppm (t, 9 H, CH₃), 2.53 ppm (q, 6 H, CH₂), 5.39nppm (bs, 4H, OCH₂CH₂), 5.77 ppm (m, 6 H, CH₂), and 5.97 ppm (m, 6 H, CH₂).

Experiment 2: YCl₃·2THF (20 g; 59 mmol) of was dissolved in 200 ml of DCM under nitrogen environment in a 1 L flask. EtCpNa (21.2 g; 183 mmol) was dissolved in 300 mL DCM in a separate flask under nitrogen environment. DCM solution of EtCpNa was charged slowly to the YCl₃·2THF containing flask under stirring at 0-5° C. After the addition completed, the resulting mixture was allowed to warm to room temperature and stirred for 3 h. Then, all the volatiles were removed, and the product was extracted in hexanes. Product was concentrated under reduced pressure resulting in 24.1 g of pale yellow crystalline EtCpsY·THF crude material with 97% purity by ¹H-NMR.

¹H-NMR (500 MHZ NMR): 1.18 ppm (bs, 4H, OCH₂CH₂), 1.2 ppm (t, 9 H, CH₃), 2.53 ppm (q, 6 H, CH₂), 5.39 ppm (bs, 4H, OCH₂CH₂), 5.77 ppm (m, 6 H, CH₂), and 5.97 ppm (m, 6 H, CH₂).

Distillation of EtCp₃Y·THF resulted 16.5 g of EtCp₃Y with 76% yield and 98.7% purity by ¹H-NMR.

¹H-NMR (500 MHZ NMR): 0.97 ppm (t, 9 H, CH₃), 2.31 ppm (q, 6 H, CH₂), 5.88 ppm (m, 6 H, CH₂), and 6.00 ppm (m, 6 H, CH₂).

¹³C-NMR (125 MHz NMR): 15.65, 23.13, 111.57 and 115.12 and 128.6

Experiment 3: YCl₃·2THF (254.7 g; 0.75 mol) was dissolved in 1500 mL of DCM under nitrogen environment in a 5 L flask. EtCpNa (270.1 g; 2.32 mol) was dissolved in 1500 mL DCM in a separate flask under nitrogen environment. DCM solution of EtCpNa was charged slowly to the YCl₃·2THF containing flask under stirring at 0-5° C. After the addition completed, the resulting mixture was allowed to warm to room temperature and stirred for overnight. Then, all the volatiles were removed, and the product was extracted in hexanes. Product was concentrated under reduced pressure, resulting in 296.3 g of pale yellow crystalline EtCp₃Y·THF crude material.

¹H-NMR (500 MHz NMR): 1.18 ppm (bs, 4H, OCH₂CH₂), 1.2 ppm (t, 9 H, CH₃), 2.53 ppm (q, 6 H, CH₂), 5.39 ppm (bs, 4H, OCH₂CH₂), 5.77 ppm (m, 6 H, CH₂), and 5.97 ppm (m, 6 H, CH₂)

¹³C-NMR (125 MHz NMR): 17, 23.79, 25.56, 71.61, 108.48, 113.77 and 126.11

Distillation of EtCp₃Y·THF resulted pale yellow EtCp₃Y with 72% yield and 99.49% purity.

¹H-NMR (500 MHZ NMR): 0.97 ppm (t, 9 H, CH₃), 2.31 ppm (q, 6 H, CH₂), 5.88 ppm (m, 6 H, CH₂), and 6.00 ppm (m, 6 H, CH₂)

¹³C-NMR (125 MHZ NMR): 15.65, 23.13, 111.57 and 115.12 and 128.6

Experiment 4: YCl₃·2THF (2 g; 5.9 mmol) of was dissolved in 30 mL of DCM under nitrogen environment in a 100 mL flask. EtCpK (2.38 g; 18 mmol) was dissolved in 30 mL DCM in a separate flask under nitrogen environment. DCM solution of EtCpK was charged slowly to the YCl₃·2THF containing flask under stirring at 0-5° C. After the addition completed, the resulting mixture was allowed to warm to room temperature and stirred for 3 h. Then, all the volatiles were removed, and the product was extracted in hexanes. The product was concentrated under reduced pressure, resulting in 2.24 g of pale yellow crystalline EtCpsY·THF crude material with 94.1% purity by ¹H-NMR.

¹H-NMR (500 MHZ NMR): 1.18 ppm (bs, 4H, OCH₂CH₂), 1.2 ppm (t, 9 H, CH₃), 2.53 ppm (q, 6 H, CH₂), 5.39nppm (bs, 4H, OCH₂CH₂), 5.77 ppm (m, 6 H, CH₂), and 5.97 ppm (m, 6 H, CH₂).

Experiment 5: YCl₃·2THF (5 g; 14.7 mmol) was dissolved in 60 mL of DCM under nitrogen environment in a 250 mL flask. MeCpNa (4.66 g; 45.7 mmol) of was dissolved in 60 mL DCM in a separate flask under nitrogen environment. A DCM solution of MeCpNa was charged slowly to the YCl₃·2THF containing flask under stirring at 0-5° C. After the addition was completed, the resulting mixture was allowed to warm to room temperature and stirred for 3 h. Then, all the volatiles were removed, and the product was extracted in hexanes. The product was concentrated under reduced pressure resulting in 5.26 g of pale yellow crystalline MeCp₃Y·THF crude material with 98% purity by ¹H-NMR.

¹H-NMR (500 MHZ NMR): 1.24 ppm (m, 4H, OCH₂CH₂), 2.22 ppm (s, 9 H, CH₃), 3.42 ppm (m, 4H, OCH₂CH₂), 5.75 ppm (m, 6 H, CH₂), and 5.93 ppm (m, 6 H, CH₂)

### Aspects

Various Aspects are described below. It is to be understood that any one or more of the features recited in the following Aspect(s) can be combined with any one or more other Aspect(s).
Aspect 1. A method comprising:
   contacting a yttrium trihalide adduct with a cyclopentadienyl compound in a presence of a solvent to form a first product,
   wherein the yttrium trihalide adduct comprises a compound of the formula:

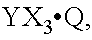

where:
X is CI, Br, or I; and
Q is an ethereal solvent;
wherein the cyclopentadienyl compound comprises a compound of the formula:

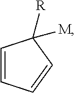

where:
   R is an alkyl; and
   M is a metal.
Aspect 2: The method according to Aspect 1, wherein the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.
Aspect 3: The method according to any one of Aspects 1-2, wherein the alkyl comprises a C₁-C₁₀ alkyl.
Aspect 4: The method according to any one of Aspects 1-3, wherein the alkyl comprises a C₁-C₈ alkyl.
Aspect 5: The method according to any one of Aspects 1-4, wherein the alkyl comprises at least one of a methyl, an ethyl, an isopropyl, or any combination thereof.
Aspect 6: The method according to any one of Aspects 1-5, wherein the alkyl is substituted with at least one substituent comprising a heteroatom.
Aspect 7: The method according to any one of Aspects 1-6, wherein the metal comprises sodium (Na), potassium (K), or lithium (Li).
Aspect 8: The method according to any one of Aspects 1-7, wherein the solvent comprises at least one of dichloromethane e (DCM), chlorobenzene, dichlorobenzene, dichloroethane (DCE), N-methyl-2-pyrrolidone (NMP), 2-methyltetrahydrofuran (2-MeTHF), di-n-butyl ether (nBu₂O) or any combination thereof.
Aspect 9: The method according to any one of Aspects 1-8, wherein the yttrium trihalide adduct comprises YX3.2THF.
Aspect 10: The method according to any one of Aspects 1-9, wherein the method does not comprise a step of adding tetrahydrofuran.
Aspect 11. The method according to any one of Aspects 1-10, wherein the first product comprises a compound of the formula:

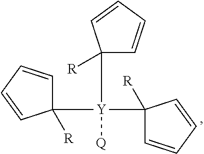

where:
   R is independently an alkyl; and
   Q is an ethereal solvent.
Aspect 12. The method according to any one of Aspects 1-11, further comprising:

removing the ethereal solvent from the first product to obtain a second product of the formula:

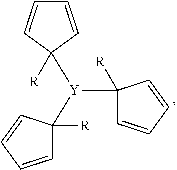

where:
   R is independently an alkyl.
Aspect 13: A composition comprising:
   a precursor compound of the formula:

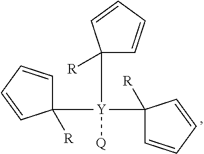

where:
   R is independently an alkyl; and
   Q is an ethereal solvent;
wherein a purity of the precursor compound in the composition is at least 95%.
Aspect 14: The composition according to Aspect 13, wherein the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.
Aspect 15: The composition according to any one of Aspects 13-14, wherein the alkyl comprises a C₁-C₁₀ alkyl.
Aspect 16: The composition according to any one of Aspects 13-15, wherein the alkyl comprises a C₁-C₈ alkyl.
Aspect 17: The composition according to any one of Aspects 13-16, wherein the alkyl comprises at least one of a methyl, an ethyl, an isopropyl, or any combination thereof.
Aspect 18: A composition comprising:
   a precursor compound of the formula:

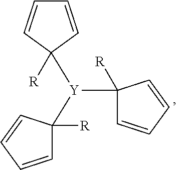

where:
   R is independently an alkyl;
   wherein a purity of the precursor compound in the composition is at least 95%.
Aspect 19: The composition according to Aspect 18, wherein the alkyl comprises a C₁-C₁₀ alkyl.
Aspect 20: The composition according to any one of Aspects 18-19, wherein the alkyl comprises at least one of a methyl, an ethyl, an isopropyl, or any combination thereof.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
contacting a yttrium trihalide adduct with a cyclopentadienyl compound in a presence of a solvent to form a first product,
wherein the yttrium trihalide adduct comprises a compound of the formula: 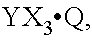
where:
X is CI, Br, or I; and
Q is an ethereal solvent;
wherein the cyclopentadienyl compound comprises a compound of the formula: 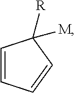
where:
R is an alkyl; and
M is a metal.

2. The method of claim 1, wherein the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

3. The method of claim 1, wherein the alkyl comprises a C₁-C₁₀ alkyl.

4. The method of claim 1, wherein the alkyl comprises a C₁-C₈ alkyl.

5. The method of claim 1, wherein the alkyl comprises at least one of a methyl, an ethyl, an isopropyl, or any combination thereof.

6. The method of claim 1, wherein the alkyl is substituted with at least one substituent comprising a heteroatom.

7. The method of claim 1, wherein the metal comprises sodium (Na), potassium (K), or lithium (Li).

8. The method of claim 1, wherein the solvent comprises at least one of dichloromethane (DCM), chlorobenzene, dichlorobenzene, dichloroethane (DCE), N-methyl-2-pyrrolidone (NMP), 2-methyltetrahydrofuran (2-MeTHF), di-n-butyl ether (nBu₂O) or any combination thereof.

9. The method of claim 1, wherein the yttrium trihalide adduct comprises YX3.2THF.

10. The method of claim 1, wherein the method does not comprise a step of adding tetrahydrofuran.

11. The method of claim 1, wherein the first product comprises a compound of the formula: 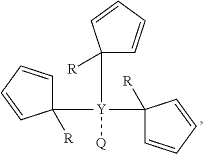
where:
R is independently an alkyl; and
Q is an ethereal solvent.

12. The method of claim 1, further comprising:
removing the ethereal solvent from the first product to obtain a second product of the formula: 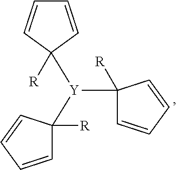
where:
R is independently an alkyl.

13. A composition comprising:
a precursor compound of the formula: 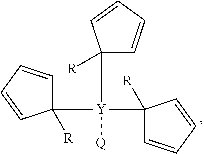
where:
R is independently an alkyl; and
Q is an ethereal solvent;
wherein a purity of the precursor compound in the composition is at least 95%.

14. The composition of claim 13, wherein the ethereal solvent comprises at least one of tetrahydrofuran (THF), 2-methyl tetrahydrofuran (2-Me THF), diethyl ether (Et₂O), dimethoxyethane (DME), di-n-butyl ether (nBu₂O) or any combination thereof.

15. The composition of claim 13, wherein the alkyl comprises a C₁-C₁₀ alkyl.

16. The composition of claim 13, wherein the alkyl comprises a C₁-C₈ alkyl.

17. The composition of claim 13, wherein the alkyl comprises at least one of a methyl, an ethyl, an isopropyl, or any combination thereof.

18. A composition comprising:
a precursor compound of the formula: 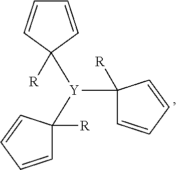
where:
R is independently an alkyl;
wherein a purity of the precursor compound in the composition is at least 95%.

19. The composition of claim 18, wherein the alkyl comprises a C₁-C₁₀ alkyl.

20. The composition of claim 18, wherein the alkyl comprises at least one of a methyl, an ethyl, an isopropyl, or any combination thereof.
